(19) United States
(12) Patent Application Publication
(10) Pub. No.: US 2004/0102066 A1
(43) Pub. Date: May 27, 2004

(54) Electrical connector with deflectable contacts and fusible elements

(75) Inventors: Joseph L. Ortega, Lemoyne, PA (US); Stuart C. Stoner, Lewisberry, PA (US)

Correspondence Address: HARRINGTON & SMITH, LLP, 4 RESEARCH DRIVE, SHELTON, CT, 06484-6212, US

(73) Assignee: FCI Americas Technology, Inc.

(21) Appl. No.: 10/302,690

(22) Filed: Nov. 21, 2002

(51) Int. Cl. H01R 12/00

(52) U.S. Cl. 439/83

(57) ABSTRACT

An electrical connector including a housing; a plurality of electrical contacts connected to the housing, and fusible elements. Each contact includes a fusible element mounting post and a deflectable spring arm with a contact surface. The electrical contacts each include a blanked, substantially flat metal member. The fusible elements are connected to the fusible element mounting posts.

### BACKGROUND OF THE INVENTION

1. Field of the Invention

The present invention relates to an electrical connector and, more particularly, to an electrical connector with deflectable contacts and fusible elements.

2. Brief Description of Prior Developments

U.S. Pat. No. 6,193,523 discloses a contact for an electrical connector with a mounting portion for a solder ball. U.S. Pat. No. 6,217,348 discloses an electrical connector with an upwardly extending contact section and a solder ball. Various other patents disclose land grid array connectors which use solder balls and deflectable spring arms, such as U.S. Pat. Nos. 6,179,624 and 5,772,451 for example.

There is a continuing desire in the area of land grid array connectors to reduce the footprint size of the connectors, or increase contact density for a predetermined footprint size. Furthermore, the length of a spring feature in a contact in a land grid array connector still needs to be long enough and the spring powerful enough to provide certain predetermined contact force requirements. The contact also preferably provides a wiping feature when making contact with another electrical component.

Manufacturing of small electrical contacts by use of a forming operation can results in contacts being manufactured with inconsistent dimensions because of variations in thickness of the stock material. The problem due to stock material thickness can be multiplied in contacts which comprise multiple bends to be formed during the forming operation. This can result in the manufacture of contacts which do not meet predetermined specifications. This can be especially detrimental in small size contacts, such as contacts used in land grid array connectors having 800 or more contacts in a 1 mm×1 mm grid which are mounted in a housing which is only about 42 mm square.

There is a desire to provide a land grid array connector which can use ball grid array technology and which also comprises a greater density of electrical contacts than previously available. However, electrical contacts of the connector still need to provide sufficient contact force, contact wiping, and stability to be commercially marketable as a dependable product with a reasonably long working life. Such a connector also needs to be manufacturable at a reasonable, marketable cost in order to be commercially acceptable to customers.

### SUMMARY OF THE INVENTION

In accordance with one aspect of the present invention, an electrical connector is provided including a housing, a plurality of electrical contacts connected to the housing, and fusible elements. Each contact includes a fusible element mounting post and a deflectable spring arm with a contact surface. The electrical contacts each include a blanked, substantially flat metal member. The fusible elements are connected to the fusible element mounting posts.

In accordance with another aspect of the present invention, an electrical connector is provided comprising a housing, a plurality of electrical contacts connected to the housing; and fusible elements. Each contact comprises a fusible element mount and a deflectable spring arm with a contact surface. A smallest dimension of material, which forms each contact, forms a thickness or width of the contact measured perpendicular to a plane of the contact intersecting the fusible element mount and the deflectable spring arm contact surface. The fusible elements are connected to the fusible element mounts.

In accordance with another aspect of the present invention, an electrical connector is provided comprising a housing, a plurality of electrical contacts connected to the housing, and fusible elements. Each contact comprises a fusible element mount and a deflectable spring arm. Each deflectable spring arm comprises a first section, a second section comprising a contact surface extending out of the housing, and a housing contact area. The housing contact area is spaced from the housing and is adapted to contact the housing when the contact surface on the second section of the deflectable spring arm is deflected towards the housing. The first section of the spring arm is deflectable during movement of the contact surface towards the housing only until the housing contact area contacts the housing. The fusible elements are connected to the fusible element mounts.

In accordance with one method of the present invention, a method of assembling an electrical connector is provided comprising steps of providing electrical contacts aligned in a row on a carry strip; providing a housing with contact receiving areas, the contact receiving areas being arranged in parallel rows and parallel columns; and inserting a first plurality of the electrical contacts into a first group of the contact receiving areas in a single insertion step, the first group of contact receiving areas including contact receiving areas in a plurality of different ones of the rows and a plurality of different ones of the columns of the contact receiving areas.

In accordance with another method of the present invention, a method of assembling an electrical connector is provided comprising steps of providing a plurality of electrical contacts by blanking the contacts from flat sheet metal, the contacts each having a substantially flat shape along a plane, the contacts each being provided with a fusible element mounting post and a deflectable spring arm with a contact surface; and inserting the substantially flat contacts into a housing, wherein the contact surface of each contact is deflectable along the plane of the contact towards its respective fusible element mounting post.

### BRIEF DESCRIPTION OF THE DRAWINGS

The foregoing aspects and other features of the present invention are explained in the following description, taken in connection with the accompanying drawings, wherein:

FIG. 1 is a exploded perspective review of an electrical connector incorporating features of the present invention shown attached to a portion of a printed circuit board and adapted to receive an electronic component;

FIG. 2 is a cross sectional view of a portion of the electrical connector shown in FIG. 1 attached to the printed circuit board;

FIG. 3 is a cross sectional view of the electrical connector and printed circuit board as shown in FIG. 2 with the electronic component attached thereto;

FIG. 4 is a top plan view of the housing of the electrical connector shown in FIG. 1;

FIG. 5 is an enlarged view of area 5 shown in FIG. 4;

FIG. 6 is a perspective view of one of the electrical contacts used in the electrical connector shown in FIG. 1;

FIG. 7 is a perspective view of some of the electrical contacts being manufactured on carry strips;

FIG. 8 is a cross sectional view taken along line 8-8 of the electrical contact shown in FIG. 6;

FIG. 9 is a perspective view of a portion of the bottom of the connector shown in FIG. 1 before a fusible element is attached to the fusible element mounting post of the electrical contact;

FIG. 10 is a top and side perspective view of a portion of the electrical connector shown in FIG. 1 shown with a cutaway section;

FIG. 11 is a bottom and side perspective view of a portion of the electrical connector shown in FIG. 1 shown with a cutaway section;

FIG. 12 is a partial elevational side view of an alternate embodiment of an electrical contact incorporating features of the present invention;

FIG. 13 is a cross sectional view of the contact shown in FIG. 12 taken along line 13-13;

FIG. 14 is a perspective view of an alternate embodiment of the contact;

FIG. 15 is a cross sectional view of the contact shown in FIG. 14 inserted into a housing;

FIG. 16 is a partial cross sectional view of an alternate embodiment of the present invention;

FIG. 17 is a perspective view of the contacts shown in FIG. 16 attached to carry strips before assembly with the housing;

FIG. 18 is a perspective view of an alternate embodiment of the contact used in the connector;

FIG. 19 is a perspective view of a plurality of the contacts shown in FIG. 18 attached to carry strips immediately after being stamped;

FIG. 20 is a perspective view of another alternate embodiment of the contact used in the connector; and

FIG. 21 is a perspective view of another alternate embodiment of the contact used in the connector.

### DETAILED DESCRIPTION OF THE PREFERRED EMBODIMENT

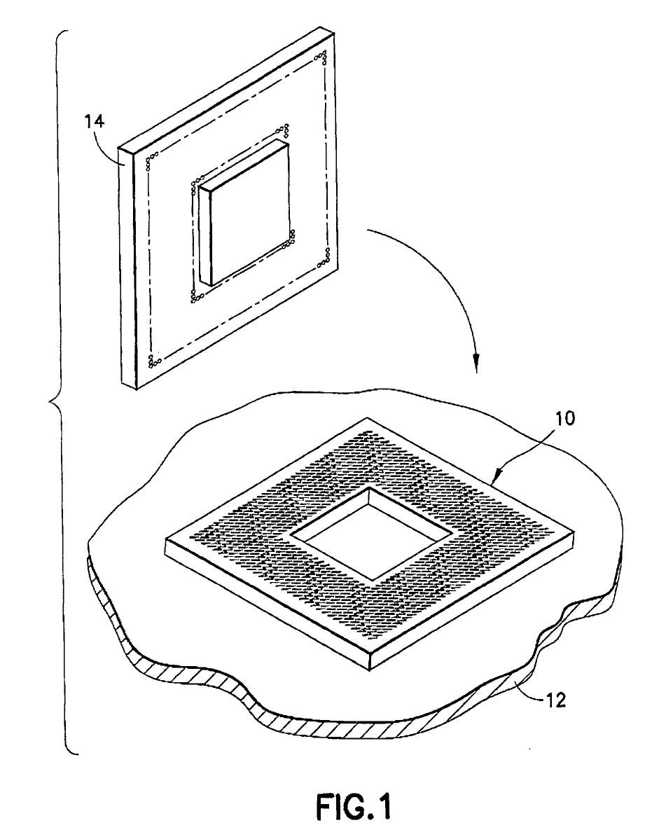

Referring to FIG. 1, there is shown a perspective view of an electrical connector 10 incorporating features of the present invention shown attached to a printed circuit board 12 and adapted to receive an electronic component 14, such as a processor. The connector 10 is adapted to electrically attach the electronic component 14 to the printed circuit board 12. Although the present invention will be described with reference to the exemplary embodiments shown in the drawings, it should be understood that the present invention can be embodied in many alternate forms of embodiments. In addition, any suitable size, shape or type of elements or materials could be used.

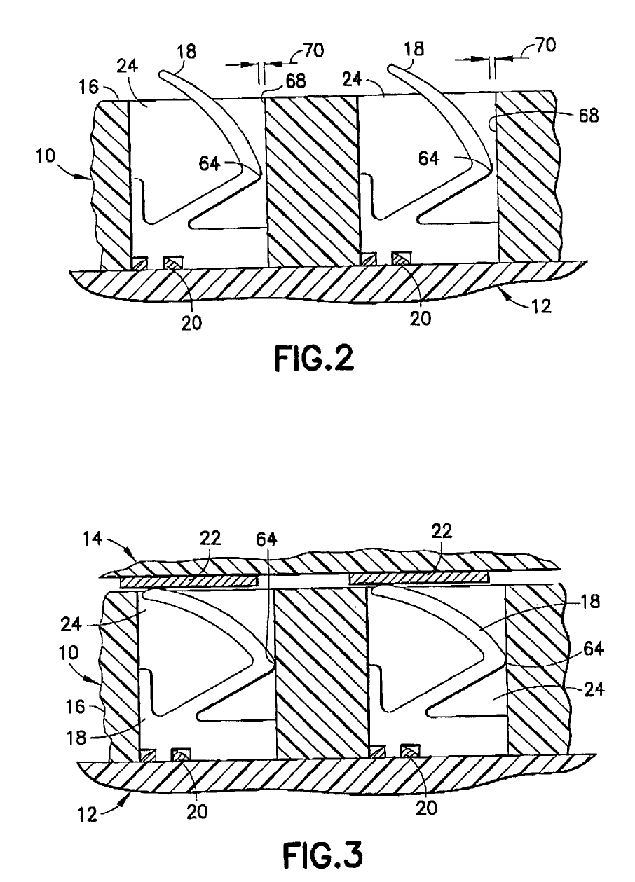

Referring also to FIGS. 2 and 3, the electrical connector 10 comprises a housing 16, electrical contacts 18, and fusible elements 20. FIG. 2 shows the electrical connector 10 before the electronic component 14 is attached thereto. FIG. 3 shows the electrical connector 10 after the electronic component 14 is attached thereto by a compression means (not shown). The electrical connector 10 generally comprises a first side 90 which is adapted to function as a land grid array (LGA) connection and a second side 92 which is adapted to function as a ball grid array (BGA) connection.

The electronic component 14, in the embodiment shown, comprises contact pads 22 on a bottom side thereof. The contact pads 22 are adapted to contact the electrical contacts 18 in a general land grid array type of connection. As seen most clearly in FIGS. 2, 10 and 11, portions of the electrical contacts 18 extend above the housing 16 and can be deflected or moved downward by the electronic component 14 when the electronic component is attached to the electrical connector 10.

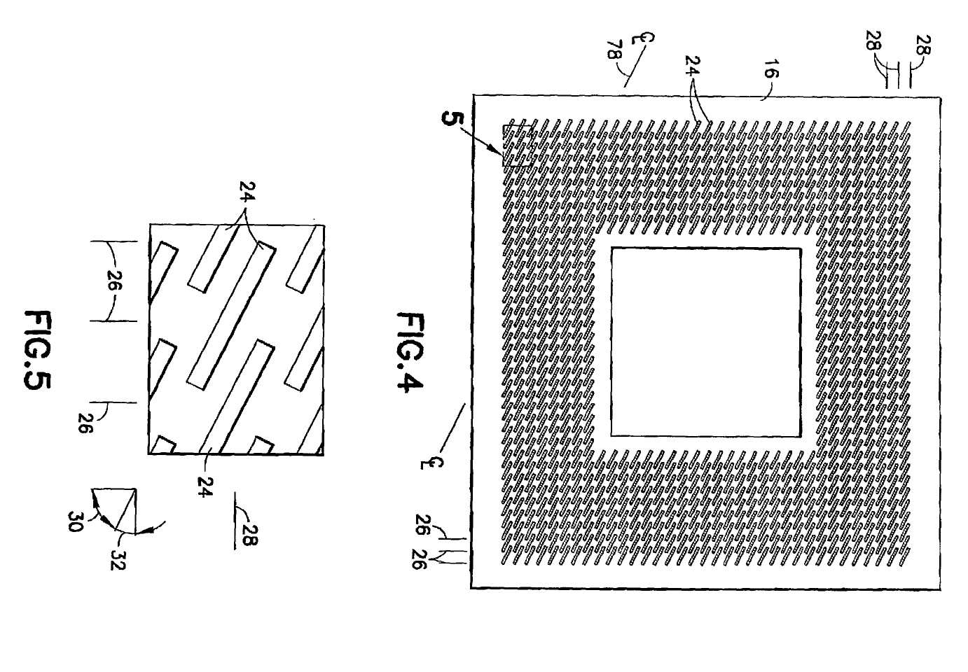

Referring also to FIGS. 4 and 5, the housing 16 is comprised of electrically insulating material. The housing 16 comprises a plurality of electrical contact receiving areas 24. The electrical contact receiving areas 24 are arranged in an array of parallel columns with axes 26 and parallel rows with axes 28 (only some of the axes are shown and labeled for the sake of clarity). In this embodiment, the array has a general square ringed shape. However, in alternate embodiments, any suitable type of array could be provided. The receiving areas 24 each comprise a generally straight rectangular area. The receiving areas 24 are aligned in a common direction and orientation relative to each other. However, in alternate embodiments, the direction or orientation of the receiving areas relative to each other could be different. The receiving areas 24 are angled relative to the axes 26, 28 of the columns and rows by angles 30 and 32. In a preferred embodiment, the angle 30 is about 63 degrees and the angle 32 is about 27 degrees. However, in alternate embodiments, any suitable angles could be provided.

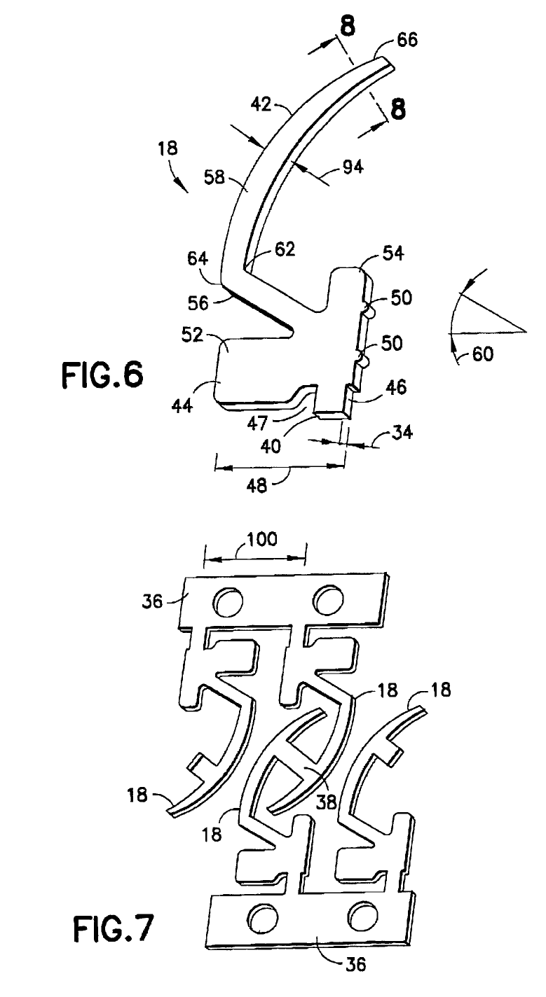

Referring also to FIG. 6, one of the electrical contacts 18 is shown. In the embodiment shown, the electrical contacts 18 are substantially identical to each other. However, in alternate embodiments, the electrical connector 10 could comprise different types of electrical contacts. The electrical contact 18 is preferably comprised of sheet metal material, such as a copper alloy for example. The contact 18 can be plated with additional material, such as nickel and gold for example. In a preferred embodiment, the thickness or width 34 of the contact 18 is about 0.15 mm. However, in alternate embodiments, any suitable type of thickness or width could be provided.

Referring also to FIG. 7, one method of manufacturing the contacts 18 can comprise taking rolled sheet metal stock material and making it into carry strips 36 and the electrical contacts 18. In the embodiment shown, the contacts 18 are formed by blanking the sheet metal stock material. Blanking comprises cutting the contacts in a general cookie cutter type of process with a substantially flat shape and without moving or deforming the contacts out of the plane of the flat stock material. The smallest dimension of the metal member is the thickness or width 34 of the contact measured perpendicular to the plane of the generally flat contact; the plane which extends along the length 48 of the contact and intersects the fusible element mount 40 and the deflectable spring arm contact surface 66.

Two of the contacts 18 are formed opposite each other with a connecting strip 38 therebetween. The connecting strip 38 is subsequently cut or severed to allow the opposing contacts 18 to be separated from each other, but still kept attached to their respective carry strip 36. However, in alternate embodiments, two of the contacts might not be formed opposite each other and, thus, a connecting strip 38 might not be used. The thickness of the sheet metal stock material is preferably about 0.15 mm thick. The thickness of the sheet metal stock material determines the thickness or width 34 of the electrical contacts 18.

Referring back to FIG. 6, the electrical contact 18 generally comprises a fusible element mount or mounting post 40, a deflectable spring arm 42, and a mounting and stabilizing section 44 therebetween. The electrical contact 18 is substantially flat because it has been blanked from the sheet metal material. The mounting post 40 extends from a bottom side of the mounting and stabilizing section 44. Open areas 46, 47 are provided at front and rear sides of the mounting post 40. The bottom of the mounting post 40 is substantially flush with the bottom of the mounting and stabilizing section 44. However, in alternate embodiments, the two bottoms might not be flush with each other.

The mounting and stabilizing section 44 includes a main section 52 and an upwardly extending stabilizing section 54. The general length 48 of the mounting and stabilizing section 44 is preferably substantially the same length as one of the contact receiving areas 24. The width 34 of the electrical contact 18 is only slightly smaller than the width of the contact receiving areas 24. The mounting and stabilizing section 44 is provided to both mount the contact 18 to the housing 16 and to prevent the mounting post 40 from moving when the deflectable spring arm 42 is moved. The location of the upwardly extending stabilizing section 54 opposite the pivot point of the deflectable spring arm 42 has been found to provide improved stability when the pivot point contacts the housing as further described and understood below.

The mounting and stabilizing section 44 is preferably blanked with barbs or protrusions 50 extending from front and rear sides thereof. The barbs or protrusions 50 enlarged the length of the mounting and stabilizing section 44 between its front and rear sides. Thus, when the mounting and stabilizing section 44 is inserted into the contact receiving area 24, the barbs or protrusions 50 can form an interference fit with the material of the housing 16 to thereby fixedly mount the mounting and stabilizing section 44 to the housing 16. The barbs or protrusions 50 are provided at the front and rear sides of the mounting and stabilizing section 44 such that pressure from the interference fit with the housing is aligned in a same plane as the flat main plane of the contact.

The deflectable spring arm 42 extends in a general cantilevered fashion from the mounting and stabilizing section 44. More specifically, in the embodiment shown, the spring arm 42 extends from a junction of the main section 52 with the upwardly extending stabilizing section 54. The spring arm 42 generally comprises a first section 56 and a second section 58. The first section 56 extends from the mounting and stabilizing section 44 at an angle 60. In a preferred embodiment, the angle 60 is about 30 degrees. However, in alternate embodiments, any suitable angle could be provided.

The second section 58 extends from the first section 56 at a pivot point 62. An exterior side of the pivot point 62 forms a housing contact area 64. In the embodiment shown, the second section 58 comprises a general curved shape. The deflectable spring arm 42 comprises a contact surface 66. The contact surface 66 is located at the end of the second section 58. The contact surface 66 is located for contacting one of the contact pads 22 of the electronic component 14.

In the past, forming operations were used to manufacture contacts for connectors having land grid array and ball grid array connection areas. However, forming operations resulted in compound stresses being formed in the contacts. Through the use of a blanking manufacturing process, rather than a forming operation, the contacts 18 can be manufactured with no compound stresses. In addition, unlike the prior art method of using a forming operation which required the forming dies to be closely monitored and continuously adjusted during a continuous forming operation of multiple contacts, no such close monitoring and continuous adjustments are needed with use of the blanking contact formation of the present invention.

Consistency among long batches of manufactured contacts can be virtually guaranteed with a blanking operation and the contact of the present invention because formation of the shape of the contacts 18 as shown in FIG. 6 is substantially independent of the thickness of the stock material. The thickness of the stock material merely affects the width 34 of the contact, and does not affect any other shape or dimension of the contact. Unlike contacts formed with bends via a forming operation, the present invention will not have the shape of the contact changed by variations is stock material thickness; only the thickness of the contact would change. The manufacturing tolerances with the use of a blanking operation has been found to be much better than with the use of a forming operation because no bending steps are needed with a blanking operation that could vary by thickness of the stock sheet metal material. This has been found to be particularly advantageous in the manufacture of very small electrical contacts.

One of the advantages of using a blanking operation to form the contacts 18 is that the dimension 94 between front and rear sides of the deflectable spring arm 42 can be relatively easily varied by a manufacturer. When this dimension 94 is changed, the manufacturer does not need to recalculate bend angles of the contact 18.

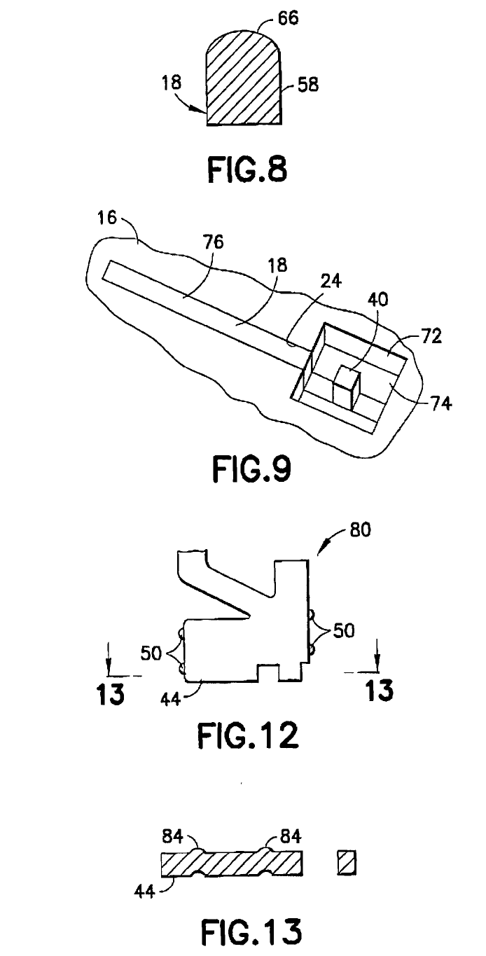

Referring also to FIG. 8, the contact surface 66 is preferably coined. However, in an alternate embodiment, the contact surface 66 might not be coined. In the embodiment shown, the deflectable spring arm 42 has a general sideways “check” (V) shape. The second section 58 forms the longer leg of the general check shape. The longer leg of the second section 58 is curved in an inward or downward direction rather than an outward direction. However, in alternate embodiments, any suitable type of shape could be provided.

As seen with reference to FIG. 2, before the electronic component 14 is attached to the electrical connector 10, the housing contact areas 64 are spaced from the opposite interior walls 68 of the housing 16 by a spacing 70. However, as seen with reference to FIG. 3, after the electronic component 14 is attached to the electrical connector 10, the housing contact areas 64 are in contact with the opposite interior walls 68 of the housing 16. In a preferred embodiment, the housing contact areas 64 contact the opposite interior walls 68 some time between initial deflection of the second section 58 and before complete deflection of the second section 58 by the electronic component 14. This provides a two-step deflection of the deflectable spring arm 42.

A first step of the two-step deflection process generally comprises the first and second sections 56, 58 both being compressed or deflected towards the mounting and stabilizing section 44. A second step of the two step deflection process generally comprises the first section 56 remaining substantially stationary and the second section 58 continuing to be deflected towards the mounting and stabilizing section 44. As the first and second sections 56, 58 are being deflected or compressed during the first step, the housing contact area 64 contacts the interior wall 68. This results in motion of the first section 56 being stopped and, thus, a transition between the first step to the second step. With the continuing compression or deflection of the second section 58, the second section 58 rotates relative to the first section 56 proximate the pivot point 62. During the second step of deflection, while the first section remained substantially stationary, the first section 56 is also adapted to absorbent some of the strain of the deflection of the second section 58.

Contact of the housing contact area 64 with the interior wall assists in stabilizing the deflectable spring arm 42. This stabilizing effect includes preventing the deflectable spring arm 42 from rotating out of alignment with the plane of the contact. In addition, the strength of the force being provided by the second section 58 against the contact pad 22 of the electronic component 14 is sufficiently strong to provide a good wiping action against the contact pads 22 with a repeatable consistency, and substantial uniformity among all the contacts 18. The contacts 18 can provide sufficient normal force against the contact pads 22 to penetrate through surface films on the pads. In addition, an increase wipe length of the contact surface 66 against the contact pads 22 reduces the amount of normal force necessary to overcome any particulate matter that might otherwise be located between the contact pads 22 and the contact surface 66.

Referring also to FIG. 9, a partial perspective view of the bottom of the connector 10 is shown. As noted above, each contact receiving area 24 has a substantially rectangular shape. However, the bottom side of the housing 16 also comprises a plurality of small recesses or depressions 72 which intersect with ends of the receiving areas 24. The recesses 72 and have a general square shape. However, in alternate embodiments, any suitable type of shape could be provided. When the contacts 18 are inserted into the contact receiving areas 24, the mounting posts 40 are located in the recesses 72. Thus, a general square or rectangular ring shaped recess 74 is formed around each of the mounting posts 40.

The rest of the bottom side 76 of the contact 18 is located substantially flush with, or slightly within, the bottom side of the housing 16. The close fit between the contacts 18 and the housing 16 at the bottom side of the housing, except for forming the ring shaped recessed 74, helps to form a barrier to wicking flow of fusible material along the contact 18 upward past the bottom side of the housing. The close fit also reduces the available surface area at the junction between the contact and the housing to also help to limit wicking flow. In one type of embodiment, an anti-wicking material can be applied to the contact to help prevent the fusible material from traveling upward along the contact 18.

Wicking of fusible material, such as tin-lead solder, past the bottom side of the housing can be a particularly acute problem when the contact has been plated with a precious metal, such as gold, at its contact surface 66. During plating, minute particles of the precious metal can be deposited at portions of the contact below the contact surface 66. These minute precious metal particles significantly increase fusible material wicking. In addition, other plating, such as nickel, can also result in increased fusible material wicking up the contact 18.

In order to help prevent the problem of fusible material wicking, the present invention provides a close fit between the contacts and the housing to help prevent fusible material from wicking upward along the contact 18. The provision of the ring shape recess 74 around the mounting post 40 also contributes to preventing wicking of the fusible material because the ring shaped recessed 74 forms a natural well or pocket for holding the fusible material 20 both before it is melted and after it is re-flow melted into connection with the printed circuit board 12.

In one type of method of inserting the contacts 18 into the contact receiving areas 24, the insertion method comprises a multi-step process. A first step would comprise inserting the contacts 18 at least partially into the receiving areas 24 via a bottom loading method while the contacts 18 are still connected to the carry strips 36. The connection of the contacts 18 to the carry strips 36 would then be severed. The next step could comprise completing insertion of the contacts into their final position in the contact receiving areas 24. However, in an alternate embodiment, any suitable type of insertion method could be used.

Because the contacts 18 are aligned in a same plane as the carry strips 36, the contacts 18 are preferably inserted into a plurality of the contact receiving areas in multiple rows and columns as symbolized by the insertion path 78 shown in FIG. 4. The insertion path 78 is angled relative to the axes 26, 28 of the columns and rows of contact receiving areas 24 by angles 30 and 32 shown in FIG. 5. Obviously, multiple parallel insertion paths would be used to fill all the contact receiving areas 24 of the housing 16. The electrical contacts are arranged in an array of rows and columns with contacts in a second one of the rows being offset and interleaved between contacts in adjacent first and third rows, and contacts in a second one of the columns being offset and interleaved between contacts in adjacent first and third columns.

In a preferred method, the contacts 18 could be inserted into the contact receiving areas 24 by a stitching method of multiple gangs or groups of the contacts 18. The gangs of contacts could be selected as modular numbers, such as one contact, two contacts, three contacts, five contacts, eight contacts, etc. for example. In an alternate embodiment, the contacts 18 could be manufactured such that they are angled on the carry strips 36. In this alternate embodiment, groups of the contacts 18 could be inserted in a single insertion step into single rows or columns rather than across multiple columns and rows at the same time.

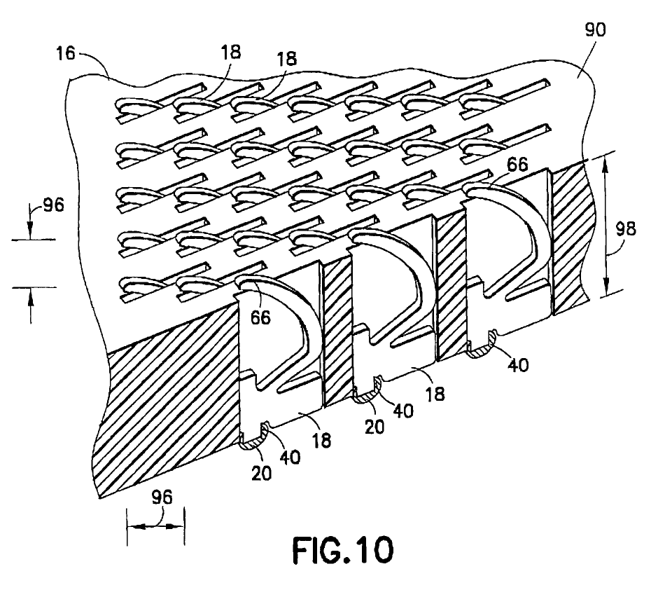

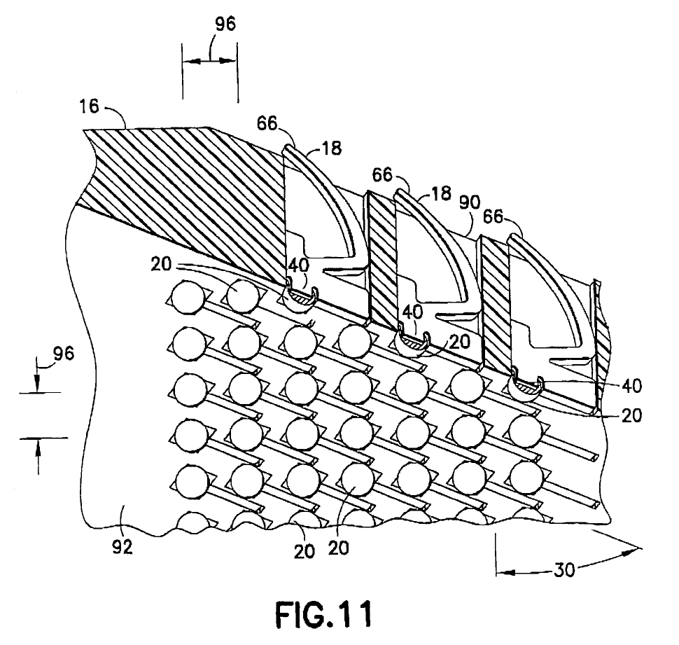

Referring now also to FIGS. 10 and 11, after the contacts 18 are inserted into the housing 16, the fusible elements or solder balls 20 are attached to the contacts 18. The fusible elements 20 are attached to the mounting posts 40 by a known method wherein solder paste is screened onto the mounting posts 40, the fusible elements 20 are positioned on the solder paste, and the fusible elements are melted to fixedly connect the elements 20 to the mounting posts 40. The assembly of the connector 10 is, thus, completed. The fusible elements 26 are located partially within the ring shaped recesses 74, but extend downward out of the recesses 74 past the bottom end of the housing 16. The fusible elements 20 can be re-flow melted onto contact areas of the printed circuit board 12 at a later time.

The end of the deflectable spring arm 42 having the contact surface 66 extends above the top surface of the housing 16. In a preferred embodiment, before the electronic component 14 is attached to the connector 10, the contact surface 66 is located at least about 0.008 in. above the top surface of the housing. However, in alternate embodiments, any suitable height could be provided. In a preferred embodiment, each contact 18 can provide a minimum of about 40 g of normal force to the contact pads 22. However, in an alternate embodiment, more or less force could be provided. Also in a preferred embodiment, the contacts 18 are each adapted to provide a minimum of at least 0.004 in. of contact wipe against the contact pads 22. However, in alternate embodiments, more or less minimum wipe could be provided. One of the features of the present invention is that the fusible elements 40 are located substantially directly below the contact surfaces 66 of their respective contacts. In order to provide the fusible elements 40 to be located substantially directly below the contact surfaces 66, the fusible element mounting posts 40 of each contact 18 have been located off-center; towards the front of the contact. The in-line arrangement of the fusible elements 40 with the contact surfaces 66 helps to prevent rocking of the contacts 18 relative to the printed circuit board 12. Thus, by reducing the amount of rocking between the contact 18 and the printed circuit board 12, the fusible element 20 is less likely to be damaged by such rocking movement.

The configuration of the contact 18 also provides a relatively short electrical path through the contact. More specifically, the ring shaped recess 74 which receives the fusible element 20 is located directly beneath the junction of the deflectable spring arm 42 with the mounting and stabilizing section 44. Thus, once electric current travels through the deflectable spring arm 42, it can travel directly downward to the fusible element 20. The present invention provides a sufficiently long enough spring in the deflectable spring arm 42 to allow for proper contact with the contact pads 22, but minimizes the length of the electrical path between the contact surface 66 and the fusible element 20.

One of the features of the present invention is the relatively high contact density for a given footprint of the connector. This relatively high contact density is provided by a combination of factors. These factors include the relatively thin width 34 of the contacts 18, the relatively thin width of the contact receiving areas 24, the relatively close spacing of the contact receiving areas 24 relative to each other in adjacent rows and columns, and the interleaving of the receiving areas 24 relative to each other for interleaving the contacts 18 relative to each other.

In the embodiment shown, the contacts 18 and fusible elements 20 are located at a pitch of 1 mm by 1 mm as shown by dimension 96. However, in alternate embodiments, any suitable pitch could be provided. The height 98 of the housing is only about 4 mm. However, in alternate embodiments, any suitable height could be provided. The spacing between contacts on the carry strip 36 is about 1.41 mm (see FIG. 6). However, in alternate embodiments, any suitable spacing could be provided.

Referring also to FIGS. 12 and 13, an alternate embodiment of the contact of the present invention is shown. In this embodiment, the contact 80 comprises a mounting and stabilizing section 82 which has been stamped or coined to form sideward extending protrusions 84. Thus, the mounting and stabilizing section 82 comprises both protrusions 50 and protrusions 84 for forming an interference fit of the mounting and stabilizing section 84 with the housing 16. However, in alternate embodiments, any suitable type of system for mounting the contacts with the housing could be provided.

In an alternate embodiment, the connector might not comprise ring shaped recesses surrounding the fusible element mounting posts, such as when the mounting posts extend below the bottom of the housing. In another alternate embodiment, the mounting posts might not be located directly below the contact surface 66, such as when the mounting post is not located proximate a front end of the contact. In another alternate embodiment, the deflection of the deflectable spring arm might not comprise a two step deflection process.

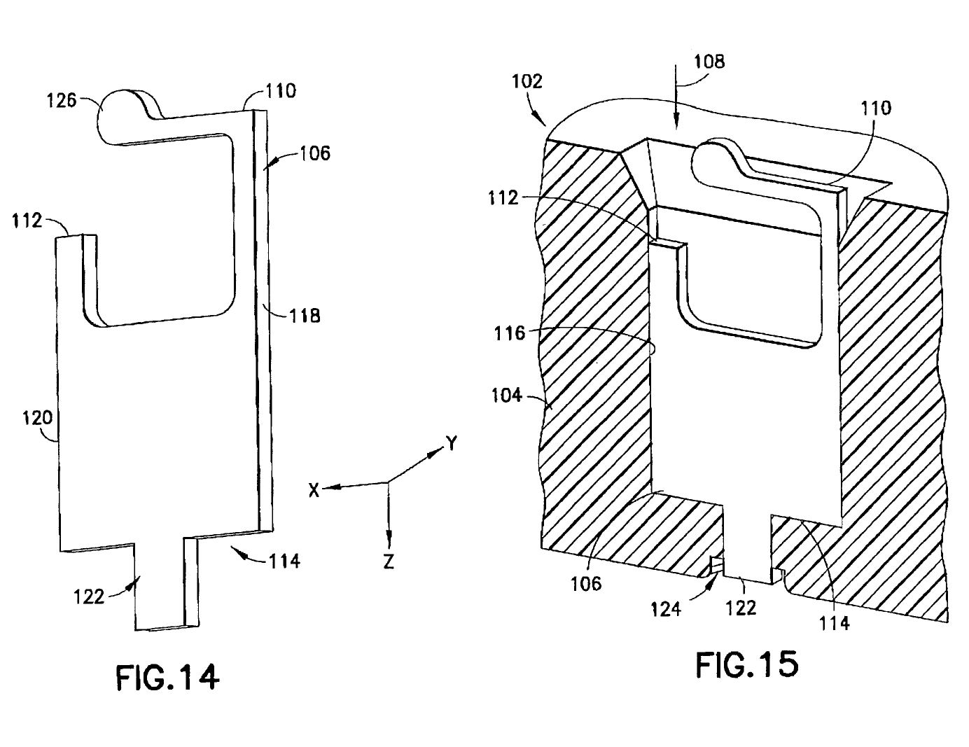

Referring now to FIGS. 14 and 15, an alternate embodiment of the present invention will be described. In the embodiment shown, the electrical connector 102 generally comprises a housing 104 and a plurality of contacts 106 orientated at an angle relative to rows and columns of the contacts similar to that shown in FIG. 4. In this embodiment, the contacts 106 are top loaded into the housing 104. The contact 106 can be flat stamped and inserted into the housing 104 in the direction as shown by arrow 108. An insertion tool (not shown) may push on the surfaces 110, 112 until contact surface 114 comes into contact with the bottom of the cavity 116 in the housing at which time the contact 106 is fully seated.

Side surfaces 118, 120 provide for alignment and guidance of the contact 106 as it is inserted into the cavity 116 to allow the BGA attachment tab 122 to enter the ball pocket 124 at the bottom of the housing 104. The side surfaces 118, 120 also isolate any stress (created when the contact abeam 126 is exercised) from the solder ball attached to the tab 122. In particular, the solder ball/solder ball tab joint, no matter if the beam 126 is exercised in the Y direction or the Z direction, is isolated from stresses created when the contact beam 126 is exercised. The solder ball tab 122 can be placed at any location along the surface 114 and the aforementioned will be valid.

If desired, the contact beam 126 can be stamped in a manner so that it is at some angle to the X direction or plane. This may be desired depending on the socket design required. The contact beam 126 can also be lengthened such that, upon exercising of the beam 126, the beam 126 contacts the surface 112. The surface 112 can, thus, act as a beam overstress stop.

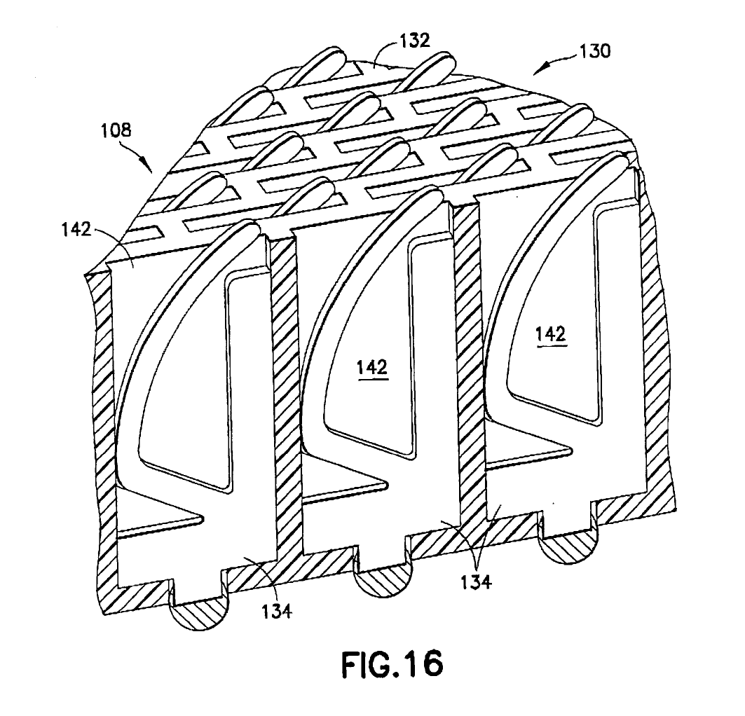

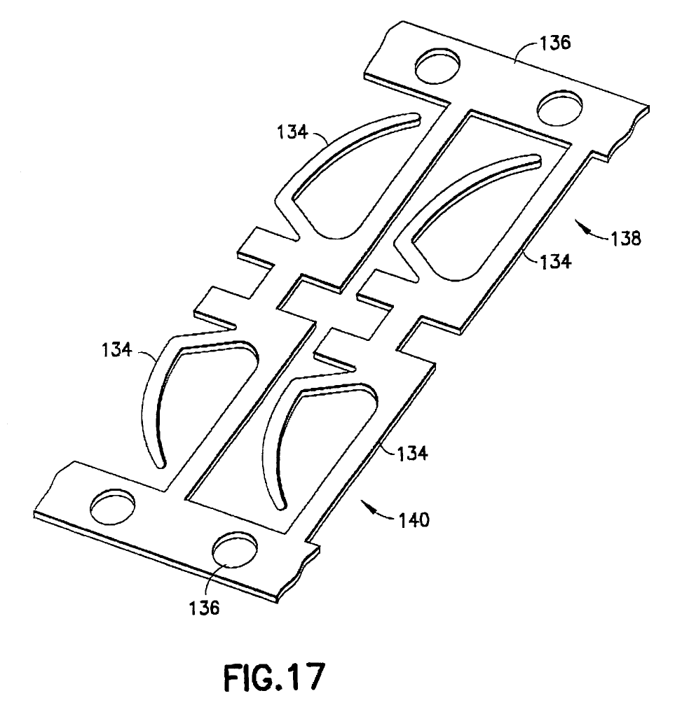

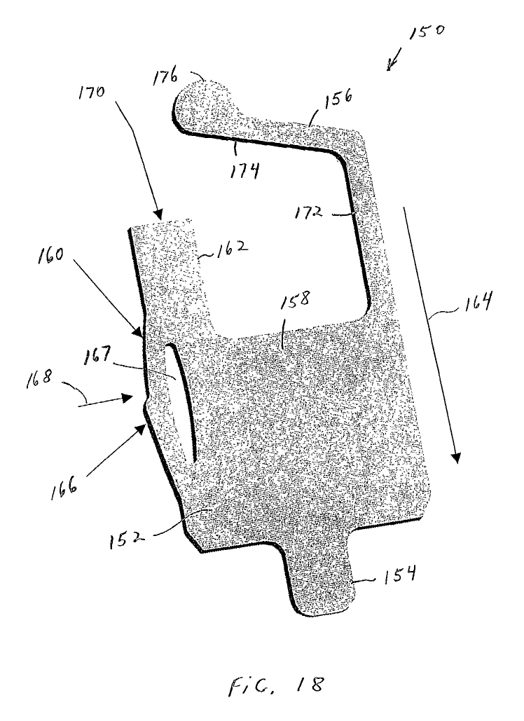

Referring now also to FIGS. 16 and 17, another alternate embodiment of the present invention will be described. In this embodiment the connector 130 generally comprises a housing 132 and contacts 134. Similar to the contacts shown in FIGS. 14 and 15, the contacts 134 are inserted into the housing 132 via a top loading insertion process as indicated by arrow 108. Similar to the contacts shown in FIGS. 2 and 3, the contacts 134 are adapted to provide a two-step deflection process. As shown in FIG. 17, the contacts 134 can be stamped from flat stock material along with the formation of carry strips 136. The two rows 138, 140 of contacts can be separated from each other and inserted into the contact receiving cavities 142 in the housing 132. The carry strips 136 can then be removed to complete the insertion process.

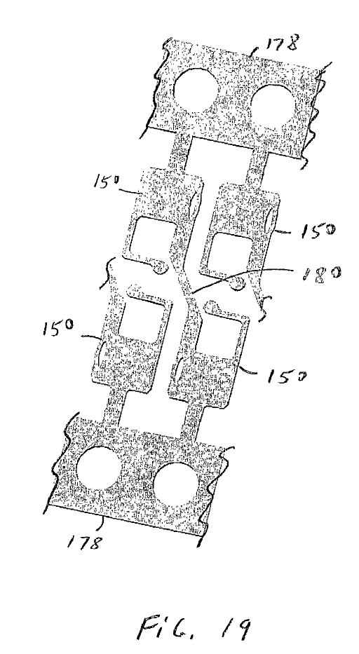

Referring now to FIG. 18, a perspective view of an alternate embodiment of the contact is shown. In this embodiment the contact 150 is comprised of sheet metal and is flat. The contact 150 includes a mounting and stabilizing section 152, a mounting post 154, and a deflectable spring arm 156. The mounting and stabilizing section 152 generally comprises a main section 158, a deflectable beam 160 at a side end, and a stabilizing and loading post 162. The contact 150 is a top end loaded contact adapted to be inserted into the connector housing as indicated by arrow 164. The deflectable beam 160 includes an exterior retention barb 166. The beam 160 is generally vertically orientated and is connected to the rest of the mounting and stabilizing section 152 at both ends of the beam. Thus, an open area 167 is formed for the beam to deflect into. The beam 160 is adapted to be deflected inward as indicated by arrow 168 when the contact 150 is inserted into the housing. The top surface 170 of the loading post 162 can be used to apply force to the contact 150 to load the contact into the housing in direction 164. In this embodiment, the spring arm 156 includes a substantially straight upwardly extending section 172 and an angled section 174 with a contact area 176 at its end.

Upon insertion of the contact 150 into a housing, the beam 160 along with the barb 166 will get compressed by some amount. The barb 166 will either dig into the housing wall or the plastic will “flow” around the barb to create some retention force. One advantage here is low insertion force, compared to a rigid retention barb, while achieving comparable retention. Another advantage is that over time the plastic is subject to “creep” which would reduce the retention force. With the above design the beam 160 would always be applying force to the plastic housing of the connector; negating any creep that might occur. This design can be used in a LGA/BGA socket, which can have in excess of 700 terminals inserted into a connector housing block. The relieved barb will greatly reduce the cumulative force exerted on the block thereby reducing warp and twist and minimizing the impact on the BGA attachment.

Referring also to FIG. 19, a plurality of the contacts 150 are shown attached to carry strips 178 after the contacts 150 are stamped. The contacts 150 are formed in to parallel rows. The contacts in one row are attached to an offset contact in the opposite row by a connecting section 180. The connecting sections 180 are removed to form the resulting top surface 170 of the post 162 shown in FIG. 18. However, in alternate embodiments, the opposite rows of contacts 150 could be connected to each other by any suitably shaped connecting section(s), and the contacts could be connected to a directly opposite contact.

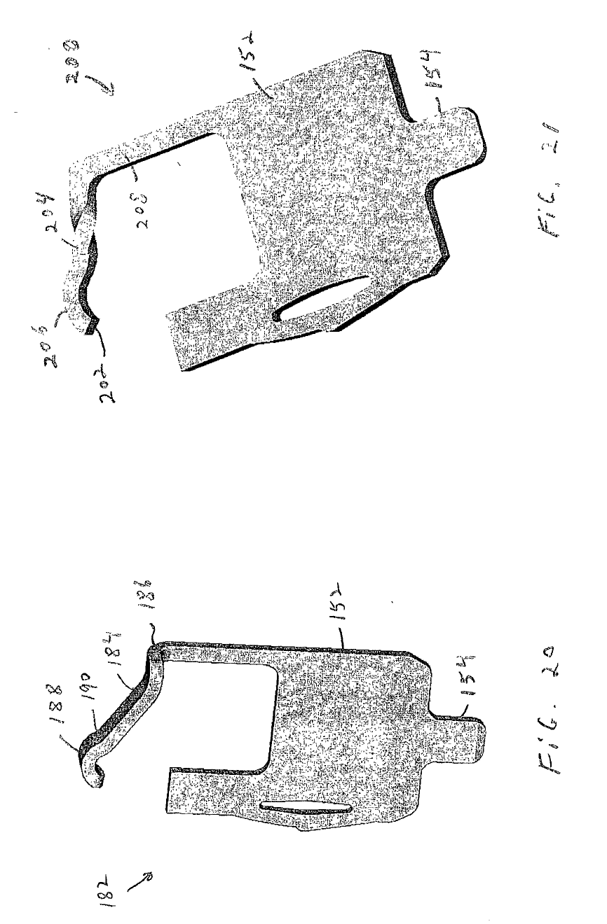

Referring now to FIG. 20, a perspective view of another alternate embodiment of the contact is shown. The contact 182 is substantially similar to the contact 150 shown in FIG. 18. The contact 182 comprises a mounting and stabilizing section 152, a mounting post 154, and a deflectable spring arm 184. The mounting and stabilizing section 152 and the mounting post 154 are the same as those shown in the embodiment shown in FIG. 18. However, the deflectable spring arm 184 is different from the deflectable spring arm 156 shown in FIG. 18. Similar to the contact 150 shown in FIG. 18, the contact 182 is comprised of a flat sheet metal member which has been stamped. However, the deflectable spring arm 184 has also been formed or bent at a bend 186. This forms a contact surface 188 which was previously a side surface 190 of the contact blank before the bend 186 was formed.

Although, in a preferred embodiment, the contact is merely stamped and not formed (such as the contact 150 shown in FIG. 18), the embodiment shown in FIG. 20 illustrates that a portion of the contact can in fact be formed if desired. In the embodiment shown in FIG. 18, the contact area 176 comprises a cut surface which is cut during the stamping process. This cut surface may be an irregular, and might not be desired when contacting the contact pads on the electrical component 14. In the to embodiment shown in FIG. 20 the bend 186 allows the former side surface 190 at the deflectable spring arm 184 to form the contact surface 188. Thus, the contact surface 188 does not comprise a cut surface. The contact surface 188 can be relatively smooth and regular to allow for easier plating of the surface 188 and more predicable and uniform contact between the contact surface 188 and the contact pads on the electrical component 14.

Referring now to FIG. 21, a perspective view of another alternate embodiment of the contact is shown. The contact 200 is substantially similar to the contact 150 shown in FIG. 18. The contact 200 comprises a mounting and stabilizing section 152, a mounting post 154, and a deflectable spring arm 202. The mounting and stabilizing section 152 and the mounting post 154 are the same as those shown in the embodiment shown in FIG. 18. However, the deflectable spring arm 202 is different from the deflectable spring arm 156 shown in FIG. 18. Similar to the contact 150 shown in FIG. 18, the contact 202 is comprised of a flat sheet metal member which has been stamped. However, the deflectable spring arm 202 has also been formed or bent at a twist 204. This forms a contact surface 206 which was previously a side surface 208 of the contact blank before the twist 204 was formed.

In the embodiment shown in FIG. 21 the twist 204 allows the former side surface 208 at the deflectable spring arm 202 to form the contact surface 206. Thus, the contact surface 206 does not comprise a cut surface. The contact surface 206 can be relatively smooth and regular to allow for easier plating of the surface 206 and more predicable and uniform contact between the contact surface 206 and the contact pads on the electrical component 14.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An electrical connector comprising:
a housing;
a plurality of electrical contacts connected to the housing, each contact comprising a fusible element mounting post and a deflectable spring arm with a contact surface, wherein the electrical contacts each comprise a blanked, substantially flat metal member; and
fusible elements connected to the fusible element mounting posts.

2. An electrical connector as in claim 1 wherein the fusible elements comprise solder balls mounted on the fusible element mounting posts.

3. An electrical connector as in claim 1 wherein each contact surface comprises a coined surface.

4. An electrical connector as in claim 1 wherein the housing and the fusible element mounting posts form general ring shaped recessed areas around each of the mounting posts.

5. An electrical connector as in claim 1 wherein each of the electrical contacts further comprise a mounting and stabilizing section located between the deflectable spring arm and the fusible element mounting post.

6. An electrical connector as in claim 1 wherein a smallest dimension of the metal member forming a thickness or width of the contact measured perpendicular to a plane of the contact intersecting the fusible element mount and the deflectable spring arm contact surface.

7. An electrical connector as in claim 1 wherein each deflectable spring arm comprises a first section, a second section comprising the contact surface extending out of the housing, and a housing contact area, wherein the housing contact area is spaced from the housing and is adapted to contact the housing when the contact surface on the second section of the deflectable spring arm is deflected towards the housing, and wherein the first section of the spring arm is deflectable during movement of the contact surface towards the housing only until the housing contact area contacts the housing.

8. An electrical connector as in claim 1 wherein the electrical contacts are arranged in an array of rows and columns with contacts in a second one of the rows being offset and interleaved between contacts in a first one and a third one of the rows, and contacts in a second one of the columns being offset and interleaved between contacts in a first one and a third one of the columns.

9. An electrical connector as in claim 1 wherein the electrical contacts are arranged in an array of rows and columns, and wherein the electrical contacts are angled relative to axes of the rows and columns.

10. An electrical connector as in claim 1 wherein the fusible element mounting post of each contact is located substantially directly beneath the contact surface of the deflectable spring arm.

11. An electrical connector as in claim 1 wherein the deflectable spring arm of each contact comprises a pivot point adapted to be moved into contact with the housing and have a portion of the deflectable spring arm rotate thereat.

12. An electrical connector as in claim 1 wherein the deflectable spring arm of each contact comprises a general sideways check shape with a longer arm of the general sideways check shape having a curved shape and the contact surface being located at an end of the longer arm.

13. An electrical connector as in claim 12 wherein the deflectable spring arm comprises a pivot point at an apex of the general sideways check shape adapted to contact the housing and have the longer arm of the deflectable spring arm rotate thereat.

14. An electrical connector as in claim 1 wherein the contacts each comprise a mounting and stabilizing section with a deflectable beam along a side end.

15. An electrical connector as in claim 14 wherein the deflectable beam has a retention barb on an exterior side thereof.

16. An electrical connector comprising:
a housing;
a plurality of electrical contacts connected to the housing, each contact comprising a fusible element mount and a deflectable spring arm with a contact surface, wherein a smallest dimension of material which forms each contact forming a thickness or width of the contact measured perpendicular to a plane of the contact intersecting the fusible element mount and the deflectable spring arm contact surface; and
fusible elements connected to the fusible element mounts.

17. An electrical connector as in claim 16 wherein the electrical contacts each comprise a blanked, substantially flat metal member.

18. An electrical connector as in claim 16 wherein the housing and the fusible element mounts form general ring shaped recesses around each of the fusible element mounts.

19. An electrical connector as in claim 16 wherein each of the electrical contacts further comprise a mounting and stabilizing section located between the deflectable spring arm and the fusible element mount.

20. An electrical connector as in claim 16 wherein each deflectable spring arm comprises a first section, a second section comprising the contact surface extending out of the housing, and a housing contact area, wherein the housing contact area is spaced from the housing and is adapted to contact the housing when the contact surface on the second section of the deflectable spring arm is deflected towards the housing, and wherein the first section of the spring arm is deflectable during movement of the contact surface towards the housing only until the housing contact area contacts the housing.

21. An electrical connector as in claim 16 wherein the electrical contacts are arranged in an array of rows and columns with contacts in a second one of the rows being offset and interleaved between contacts in a first one and a third one of the rows, and contacts in a second one of the columns being offset and interleaved between contacts in a first one and a third one of the columns.

22. An electrical connector as in claim 16 wherein the electrical contacts are arranged in an array of rows and columns, and wherein the electrical contacts are angled relative to axes of the rows and columns.

23. An electrical connector as in claim 16 wherein the fusible element mount of each contact is located substantially directly beneath the contact surface of the deflectable spring arm.

24. An electrical connector as in claim 16 wherein the deflectable spring arm of each contact comprises a pivot point adapted to contact the housing and have a portion of the deflectable spring arm rotate thereat.

25. An electrical connector as in claim 16 wherein the deflectable spring arm of each contact comprises a general sideways check shape with a longer arm of the general sideways check shape having a curved shape and the contact surface being located at an end of the longer arm.

26. An electrical connector as in claim 25 wherein the deflectable spring arm comprises a pivot point at an apex of the general sideways check shape, the pivot point being adapted to contact the housing and have the longer arm of the deflectable spring arm rotate thereat.

27. An electrical connector as in claim 16 wherein the contacts each comprise a mounting and stabilizing section with a deflectable beam along a side end.

28. An electrical connector as in claim 27 wherein the deflectable beam has a retention barb on an exterior side thereof.

29. An electrical connector comprising:
a housing;
a plurality of electrical contacts connected to the housing, each contact comprising a fusible element mount and a deflectable spring arm, each deflectable spring arm comprising a first section, a second section comprising a contact surface extending out of the housing, and a housing contact area, wherein the housing contact area is spaced from the housing and is adapted to contact the housing when the contact surface on the second section of the deflectable spring arm is deflected towards the housing, and wherein the first section of the spring arm is deflectable during movement of the contact surface towards the housing only until the housing contact area contacts the housing; and
fusible elements connected to the fusible element mounts.

30. An electrical connector as in claim 29 wherein each electrical contact comprises a blanked, substantially flat metal member.

31. An electrical connector as in claim 30 wherein a smallest dimension of the metal member forming a thickness or width of the contact measured perpendicular to a plane of the contact intersecting the fusible element mount and the deflectable spring arm contact surface.

32. An electrical connector as in claim 29 wherein the housing and the fusible element mounts form general ring shaped recesses around each of the fusible element mounts.

33. An electrical connector as in claim 29 wherein each of the electrical contacts further comprise a mounting and stabilizing section located between the deflectable spring arm and the fusible element mount.

34. An electrical connector as in claim 29 wherein the electrical contacts are arranged in an array of rows and columns with contacts in a second one of the rows being offset and interleaved between contacts in a first one and a third one of the rows, and contacts in a second one of the columns being offset and interleaved between contacts in a first one and a third one of the columns.

35. An electrical connector as in claim 29 wherein the electrical contacts are arranged in an array of rows and columns, and wherein the electrical contacts are angled relative to axes of the rows and columns.

36. An electrical connector as in claim 29 wherein the fusible element mount of each contact is located substantially directly beneath the contact surface of the deflectable spring arm.

37. An electrical connector as in claim 29 wherein the deflectable spring arm of each contact comprises a general sideways check shape with the second section of the spring arm forming a longer arm of the general sideways check shape, the longer arm having a curved shape and the contact surface being located at an end of the longer arm.

38. An electrical connector as in claim 37 wherein the deflectable spring arm comprises a pivot point at an apex of the general sideways check shape, the pivot point having the housing contact area and being adapted to have the longer arm of the deflectable spring arm rotate thereat.

39. A method of assembling an electrical connector comprising steps of:
providing electrical contacts aligned in a row on a carry strip;
providing a housing with contact receiving areas, the contact receiving areas being arranged in parallel rows and parallel columns; and
inserting a first plurality of the electrical contacts into a first group of the contact receiving areas in a single insertion step, the first group of contact receiving areas including contact receiving areas in a plurality of different ones of the rows and a plurality of different ones of the columns of the contact receiving areas.

40. A method of assembling an electrical connector comprising steps of:
providing a plurality of electrical contacts by blanking the contacts from flat sheet metal, the contacts each having a substantially flat shape along a plane, the contacts each being provided with a fusible element mounting post and a deflectable spring arm with a contact surface; and
inserting the substantially flat contacts into a housing, wherein the contact surface of each contact is deflectable along the plane of the contact towards its respective fusible element mounting post.
